(19) United States
(12) Patent Application Publication
(10) Pub. No.: US 2013/0062517 A1
(43) Pub. Date: Mar. 14, 2013

(54) ACCELERATED HIGH RESOLUTION DIFFERENTIAL ION MOBILITY SEPARATIONS USING HYDROGEN CARRIER GAS

(71) Applicants: Alexandre A. Shvartsburg, Richland, WA (US); Richard D. Smith, Richland, WA (US)

(72) Inventors: Alexandre A. Shvartsburg, Richland, WA (US); Richard D. Smith, Richland, WA (US)

(73) Assignee: BATTELLE MEMORIAL INSTITUTE, Richland, WA (US)

(21) Appl. No.: 13/282,252

(22) Filed: Oct. 26, 2011

Related U.S. Application Data
(63) Continuation-in-part of application No. 13/230,539, filed on Sep. 12, 2011, now abandoned.

(51) Int. Cl. H01J 49/40

(52) U.S. Cl. 250/282; 250/288

(57) ABSTRACT

A new carder gas medium for differential or field asymmetric waveform on mobility spectrometry (FAIMS) is disclosed. Separations in this medium generally follow those in He/N₂ mixtures known in the art, but are faster and/or exhibit previously unachievable resolving power, peak capacity, and species resolution. The new medium is resistant to electrical breakdown, readily available, and less expensive than current buffers involving substantial He fractions. Performance gains apply broadly across analyte classes, including peptides and other larger biomolecules, and to ions of various charge states. Improvements are particularly large for larger and singly charged ions with lower mobility in gases.

### CROSS REFERENCE TO RELATED APPLICATION

This application dams priority from U.S. patent application Ser. No. 13/230,539 filed 12 Sep. 2011 entitled “Rapid High Resolution Differential on Mobility Separations Using Hydrogen Carrier Gas”, which reference is incorporated herein in its entirety.

### STATEMENT REGARDING RIGHTS TO INVENTION MADE UNDER FEDERALLY-SPONSORED RESEARCH AND DEVELOPMENT

This invention was made with Government support under Contract DE-AC05-76RLO1830 awarded by the U.S. Department of Energy. The Government has certain rights in the invention.

### FIELD OF THE INVENTION

The invention relates generally to analytical methods employing ion mobility spectrometry (IMS), and particularly differential IMS.

### BACKGROUND OF THE INVENTION

The dominant instrument platform for analyses of complex samples, ubiquitous in biological and environmental applications, is mass spectrometry (MS) preceded by separation step(s). Such separations have usually been performed in solution using a variety of liquid chromatography (LC) or capillary electrophoresis (CE) techniques, but post-ionization methods based on on mobility spectrometry (IMS) are becoming increasingly common. The major attractions of IMS are (i) dramatic acceleration of separations allowed by high-speed on motion in gases and (ii) specificity that differs from, and often exceeds, that of LC or CE. All IMS approaches may be grouped into conventional IMS, based on the absolute on mobility K, and differential or field asymmetric; waveform IMS (FAIMS), exploiting the increment of K as a function of electric field intensity (E). While FAIMS had emerged later than conventional IMS, it has developed rapidly over the last decade and is becoming broadly accepted, with FAIMS pre-separation stages for various MS systems introduced or about to be introduced by several major vendors.

Early FAIMS/MS systems commonly featured FAIMS units with curved (cylindrical and/or spherical) electrodes. That has translated into ion filtering in curved annular gaps with inhomogeneous electric field that allows a range of equilibrium conditions depending on ion location in the gap. Their major drawback was a low resolving power (R) of ˜5-10 and therefore modest peak capacity, which constrained the method utility. For example, a promising FAIMS application is separation and identification of peptide isomers such as sequence inversions and variants with different localizations of post-translational modifications (PTMs)—one of the most topical proteomics problems. However, few such isomers are separable using FAIMS with R˜10. Decreasing the gap curvature reduces the gradient of E and thus improves resolution, which maximizes in planar gaps with homogeneous field. Latest FAIMS and FAIMS/MS products increasingly utilize planar gap geometries.

Another path to better resolution is optimizing the buffer (carrier) gas composition. In particular, mixtures comprising helium (He) or vapors of water or volatile organics have been successfully used. Adding He to the nitrogen (N₂) gas generally increases R, and He/N₂ mixtures with ˜50% He (v/v) are frequently employed. In planar FAIMS devices, use of up to 75% He has enabled raising R to ˜30 for singly-charged ions and ˜100-200 for multiply-charged ones (with the “standard” filtering time of t=0.2 s). However, He strongly promotes the electrical breakdown in gas, the threshold for which drops with increasing He content. This limits the He fraction in usable mixtures, for He/N₂ to ˜50-75% (depending on the peak E) though higher fractions would improve separations. Addition of vapors can dramatically enhance resolution, but strong and unpredictable dependence on the particular ion and vapor species as well as vapor concentration require case-by-case method development. Vapors have so far not helped analyses of large and multiply charged ions including proteins and peptides of bioanalytically relevant sizes generated by electrospray ionization (ESI), in part because those ions tend to charge-reduce by proton transfer to vapor neutrals that have substantially higher proton affinities.

Close to the threshold, an electrical breakdown may be triggered by minor variations of peak field, ambient gas pressure, temperature, or composition, and/or changes of nature and quantity of ions in the gap during FAIMS scan or due to source intensity fluctuations. Such breakdown causes analysis failure and sample loss, poor reproducibility because of inevitable (intended or not) changes of waveform parameters when re-starting the system, and often equipment damage. It also severely complicates the automation of analyses by necessitating dose operator oversight. Stable operation requires tight control of all relevant parameters and tolerance of waveform-generating electronics to shorting across the load should the breakdown still happen. Many existing FAIMS power supplies, including those with active feedback loops adopted in some current commercial systems, cannot withstand such breakdowns and thus have to be operated significantly below the breakdown threshold despite the diminished performance.

As usual for separations in media, the resolving power and peak capacity of FAIMS scale as t^{1/2}, here because the peak widths scale as t^{-1/2}. This is rigorous in the limit of infinite t, where the time for onset of filtering (required for ions to fill the gap of finite width by migrating toward electrodes) is negligible in comparison. With long filtering times required for high FAIMS resolution, the above scaling is a fair approximation. Thus even higher R up to ˜60 for 1+ ions and ˜330 for multiply-charged peptides are achieved by extending t from 0.2 s to ˜0.7 s. However, the minimum time for a FAIMS scan, accounting for the downtime needed for ions to leave the gap once E_{c} is incremented, is ˜2 pt (where p is peak capacity). This renders even t=0.2 s too long for many applications, most importantly integration into the LC/MS pipeline without slowing the LC gradient or sacrificing the peak capacity through selective stepping. For example, a scan with p˜130 for tryptic digests (provided by the maximum R˜200) takes at least ˜1 min., which already substantially exceeds the eluting peak width in modern HPLC. Raising the resolving power via extending t augments the problem as both p and t increase. For instance, a scan with p˜200 achievable in t=0.5 s takes at least ˜3 min., or >10 times the peak widths in practical HPLC. Instead, there is a need to improve the resolution or throughput without compromising the other metric, and to increase both from present levels.

Helium is also expensive, and is projected to become yet more expensive and in short supply in the near future. The flow rate of buffer gas to currently common FAIMS devices (Q) is ˜2-4 L/min, and the cost of consumed He significantly impedes the acceptance of FAIMS, particularly outside of the US where He is more expensive and harder to procure. Hence, a more economical substitution for He is needed.

Accordingly, new approaches are desired that yield high FAIMS resolving power and separation speed without coming dose to the electrical breakdown as occurs with existing buffer media, while using readily available and inexpensive gases. The present invention meets these needs by addressing various problems known in the art. Additional advantages and novel features of the present invention will be set forth as follows and will be readily apparent from the descriptions and demonstrations set forth herein. Accordingly, the following descriptions of the present invention should be seen as illustrative of the invention and not as lira ting in any way.

### SUMMARY OF THE INVENTION

In one aspect, the invention is a FAIMS buffer medium comprising H₂, typically as the dominant component. In some embodiments, the medium is a binary gas mixture, in particular H₂/N₂ or H₂/He. In other embodiments, the medium includes two or more other gases, in particular He, N₂, argon (Ar), carbon dioxide (CO₂), or sulfur hexafluoride (SF₆) in various amounts. Such components may enhance the non-Blanc effect for greater FAIMS resolution and peak capacity and/or suppress electrical breakdown through electron scavenging. In still other embodiments, the medium includes one or more vapors to enhance the resolution and/or peak capacity.

In another aspect, the invention includes a process for raising the resolving power and resolution/peak capacity of FAIMS while increasing the separation speed and thus throughput, by deploying a carrier gas comprising H₂.

In the exemplary embodiment, the FAIMS device operates at ambient (atmospheric) pressure and field frequency of 750 kHz. In other embodiments, the pressure ranges from 50 Torr (0.066 atm) to about 1 atm, or from about 1 atm to 5 atm, while the frequency ranges from about 200 kHz to about 30 MHz.

In various embodiments, the FAIMS device of the invention is coupled to a mass spectrometer, a conventional IMS stage [such as drift-tube IMS, traveling-wave IMS, or differential mobility analyzer (DMA)], another FAIMS stage, a spectrometer (such as photoelectron or photodissociation spectrometer), or combinations thereof.

### BRIEF DESCRIPTION OF THE DRAWINGS

FIG. 1 shows separation of reserpine and 3,4-dehydroreserpine ions in H₂/N₂ mixtures.

FIGS. 2a-2c compare separation properties for reserpine from FIG. 1 to those in benchmark He/N₂ mixtures.

FIG. 3 shows 10 consecutive spectral windows for reserpine.

FIG. 4 shows the separation of nitropeptide isomers in H₂/N₂ mixtures.

FIG. 5 compares separation properties for Syntide 2 ions in H₂/N₂ and He/N₂ mixtures.

FIGS. 6a-6b show 10 and 7 consecutive spectral windows for 2+ and 3+ ions of Syntide 2, respectively.

FIG. 7 shows the spectra for APLpSFRGSLPKpSYVK ions in H₂/N₂ and He/N₂ mixtures.

FIG. 8 shows E_{c} values in H₂/N₂ mixtures relative to those for the same species in N₂.

### DETAILED DESCRIPTION

The invention is an analytical method that employs hydrogen (H₂), alone or mixed with other gases and/or vapors, as a buffer in IMS or FAIMS devices. In comparison with He used in state-of-the-art systems, H₂ allows much higher E values without electrical breakdown. In FAIMS, this leads to higher resolution (with the same filtering time), faster filtering (at equal resolution), or both. Hydrogen is also cheaper and more readily available than He, especially outside the US. In particular, H₂ may be generated in situ using simple inexpensive approaches known in the art, e.g., by electrolyzing water. In one embodiment, H₂ and another gas make a binary buffer. In particular, He/N₂ buffers commonly employed in FAIMS are replaced by H₂/N₂, with the H₂ fraction preferably over ˜70%. The same substitution may be made in other FAIMS buffers comprising He, such as He/CO₂ or He/SF₆. The H₂/He mixtures may be useful in certain applications. In one embodiment, the buffer comprises H₂ and at least two other gases. These include, but are not limited to, some or all of He, N₂, Ar, CO₂, and SF₆. In other embodiments, the buffer comprising H₂ and possibly other gas or gases also includes a vapor of at least one substance. In some embodiments, the substance is a volatile organic. In some embodiments, the at least one substance includes a volatile organic. These new buffers allow achieving one or more of the goals important to FAIMS analyses: (1) higher R, overall peak capacity, or resolution of specific analytes, (2) selectivity differing from that for known buffers, (3) improved operational stability, reproducibility, and the safety and service life of equipment due to the removal of electrical breakdown risks, and (4) faster ion filtering.

### Fundamentals of Resolving Power for FAIMS Using Hydrogen

Broad metrics for separation methods include the resolving power—the separation parameter for a peak divided by its full width at half maximum (w), and the peak capacity—the separation space for a given analyte set divided by w. The separation parameter in FAIMS is the compensation field (E_{c}), the intensity of the time-independent field superposed on the asymmetric field to equilibrate an ion in the gap. The metric relevant for specific analytes is resolution (r)—the E_{c} difference between two peaks divided by w. Hence narrowing the peaks equally benefits all separation power metrics.

In planar FAIMS devices operating at moderate E, the peak widths are proportional to K^{-1/2}. This scaling is not exact, mostly because the anisotropy of ion diffusion at high E in FAIMS breaks the linear dependence of diffusion coefficient (Ω) on mobility by the Einstein equation, but is a fair approximation for the “full-size” (not miniaturized) analyzers. Hence making ions more mobile narrows the peaks and improves all separation power metrics. By the Mason-Schamp equation, ion mobilities in the low-field limit are inversely proportional to the 1^{st}-order collision integral (cross section) between the ion and gas molecule (Ω) and the square root of reduced mass for the ion—gas molecule pair (μ). As the mobilities of analytically relevant larger ions at moderate E deviate from the low-field values only incrementally, same approximately applies in FAIMS. Relevant ions are much heavier than typical gas molecules (H₂, He, N₂, Ar, or CO₂), hence the μ value virtually equals the gas molecule mass, M. Thus the mobilities for ions of the same Ω in He (M=4 Da) exceed those in N₂ (M=28 Da) by 7^{1/2}=2.65 times. As the He atom is smaller and less polarizable than the N₂ molecule, it also has lower cross sections with ions. This factor increases the mobilities in He (at room temperature) relative to those in N₂ by ˜10-50% (more so for smaller ions where the collision partner identity is more important), and typical biomolecular ions are more mobile in He than in N₂ by ˜3-4 times (at and around room temperature). By Blanc's law, the mobilities in He/N₂ mixtures then exceed those in N₂ by ˜1.5-1.6 times at 50% He and ˜2-2.3 times at 75% He. (Although that law is not accurate at higher fields, it suffices for such estimates.) The peaks in FAIMS narrow accordingly, contributing about half to the resolution gains upon He addition. The other half comes from expanding separation space, due to (i) stronger K(E) dependences in He compared to N₂ and (ii) non-Blanc phenomena that magnify those dependences in mixtures of molecules forming dissimilar potentials with ions, such as He and N₂.

These considerations for He/N₂ are supported by experiments and are extendable to H₂ and its mixtures. The key advantage of H₂ is its high breakdown thresholds, lower than those for N₂ but greatly exceeding those for He. For a dc voltage over a 2-mm gap at atmospheric pressure and temperature, the values are ˜7.5 kV for N₂, ˜4.5 kV for H₂, and ˜1 kV for He. The thresholds for high-frequency rf voltages are slightly greater, and present device with a 1.88-mm gap sustains H₂/N₂ with up to ˜92% H₂ at the maximum peak voltage (dispersion voltage, DV) of 5.4 kV—the highest reported for FAIMS (versus 50% He in He/N₂) and 100% H₂ at ˜5 kV. Given that CO₂ and SF₆ resist breakdown better than N₂, nearly all mixtures of H₂ with N₂, CO₂, and/or SF₆ can be employed without breakdown. He/H₂ mixtures will break down at some He fraction depending on E, but can be useful up to that point.

As H₂ molecules (M=2 Da) have half the mass of He, the mobilities of ions with the same Ω in H₂ are 2^{1/2}=1.41 times those in He. No IMS work for larger ions has employed H₂, thus no cross sections with H₂ have been reported. These would exceed Ω with He because H₂ is larger (as a diatomic) and more polarizable (α=0.82 vs. 0.20 Å³), resulting in deeper ion-molecule potentials. However, H₂ is smaller and less polarizable than N₂ (α=1.77 Å³), meaning shallower potentials and smaller values. Thus, the difference of Ω between He and H₂ should be less than ˜10-50% found between He and N₂, and mobilities in H₂ are likely greater than those in He, at least for relevant larger ions where Ω depends on the gas molecule only weakly. Thus, the peaks for such ions in FAIMS using H₂/N₂ mixtures should compare to those in He/N₂ with the same N₂ fractions, or be slightly (up to ˜15%) narrower.

Of key importance is the capability to operate at up to ˜100% H₂, impossible with He as discussed above. For the same Ω, mobilities in H₂ exceed those in N₂ by 14^{1/2}=3.74 times, as opposed to the (Blanc-law) factor of 1.45 in He/N₂ mixtures with the maximum 50% He at DV=5.4 kV. Considering the smaller cross sections in H₂ than in N₂, mobilities in H₂ should be ˜4˜5 times those in N₂, vs. the 1.5-1.6 times in 1:1 He/N₂. Thus substituting H₂ for He in mixtures with N₂ should allow increasing K values by up to ˜2.7-3.1 times, thereby narrowing the peaks in FAIMS by an additional ˜1.6-1.8 times.

As stated above, the R and p values are also proportional to the E_{c} and separation space, respectively. Experiments for representative analytes (shown below) demonstrate that E_{c} values and thus separation space widths in H₂1N₂ and He/N₂ mixtures are dose for N₂ concentrations of 50% or more. However, as the H₂ fraction goes to 100%, the E_{c} values exceed those in He/N₂ with 50% He, adding to the advantage of narrower peaks. As a result, the FAIMS resolving power achieved in equal time using H₂/N₂ mixtures far exceeds that in permissible He/N₂ compositions.

Ion beams in gases are broadened by diffusion and space-charge expansion due to Coulomb repulsion. The former is independent of the ion density σ, while the latter scales as σ². The σ value in FAIMS is limited by Coulomb expansion eliminating excess ions, thus diffusion dominates. For optimum performance, the effective gap width of a FAIMS device (mechanical width, g, less the amplitude of ion oscillations in the FAIMS cycle, d) must compare with the beam broadening during the filtering time t. The D and K values are approximately proportional at moderate E, as stated above. Hence the beams spread in H₂ much faster than in N₂ or permissible He/N₂ mixtures, by ˜3 times relative to 1:1 He/N₂ based on the mobilities estimated above (and actually more because of enhanced field heating of ions). The value of d is proportional to mobility and thus is scaled by the same factor. For typical polyatomic ions with K ˜1-2 cm²/(Vs) in N₂, this means going from d˜0.15-0.3 mm in 1:1 He/N₂ to d˜0.4-1 mm in H₂ (for the present 2:1 bisinusoidal waveform with DV=5.4 kV and 750 kHz frequency). With unchanged gap width, nearly all ions for many species are thus non-selectively destroyed on electrodes over the typical t period (0.2 s for g˜2 mm). For many analytes, this limits practical H₂/N₂ mixtures to ˜50-80% H₂, capping the resolution gains provided by H₂ usage in existing FAIMS devices not designed for such buffers. With the diffusional broadening scaling as (Dt)^{1/2}, the effective gap width suitable for 1:1 He/N₂ gas has to be raised by at least ˜60-80% for H₂, e.g., from the present ˜1.6-1.7 mm to ˜2.6-3.1 mm. This translates into an increase of physical width from g˜1.9 mm to g˜3.2-3.8 mm (at least). Then, for constant E, the DV value is to be scaled in proportion, i.e., to ˜9-11 kV from 5.4 kV.

The present invention can utilize higher H₂ fractions with faster separations. Had the oscillation amplitude remained constant, one would have to decrease t by a factor of 1/D, or ˜3 times as estimated above. The greater d value computed above decreases the effective gap width by ˜15-40% (from ˜1.6-1.7 mm in 1:1 He/N₂ to ˜0.9-1.5 mm in H₂). To compensate, t must be shortened by an additional ˜1.4-3 times, or ˜4-10 times total, i.e., from 0.2 s to 0.02-0.05 s. This would be achieved by increasing the rate of gas flow to the FAIMS device, e.g., from the “standard” 2 L/min (for t=0.2 s) to Q˜8-20 L/min. The maximum flow at a given H₂ fraction is presently capped by the vacuum pumping limitations of the MS stage in the FAIMS/MS platform, but can be lifted using other MS systems with a greater pumping capacity. (A better and more economical solution would be to shorten the gap, which would also reduce the load capacitance and thus the required power of waveform generator). The highest Q employed herein is 2.7 L/min, leading to the minimum t˜0.15 s, but the invention is not limited thereto.

According to the above square-root scaling, reducing t by ˜25% (e.g., from 0.2 s at Q=2.0 L/min to 0.15 s at Q=2.7 L/min) would broaden the peaks by ˜12%. This is much less than the benefit of higher ion mobilities in H₂ estimated above as ˜1.6-1.8 times.

For purposes of the present invention, the terms “hydrogen” and “H₂” comprise all molecular isotopologues, including ¹H¹H, ²H²H or D₂ (the deuterium dimer), and ¹HD. While normal hydrogen (¹H¹H) is by far the cheapest and should generally perform best because of lowest mass leading to the highest ion mobilities, heavier isotopologues may be advantageous in some applications. The term “differential IMS” comprises all methods for separation or characterization of ions based on the dependence of their transport through gases on the intensity or direction of the electric field, including, but not limited to, known FAIMS technology that is controlled by the first derivative of ion mobility as a function of field intensity. In particular, higher-order differential (HOD) IMS based on the second or higher derivatives of the mobility function as detailed in U.S. Pat. No. 7,449,683, and IMS with alignment of dipole direction (IMS-ADD) where the field aligns ion dipoles depending on the field intensity and dipole moment as detailed in U.S. Pat. No. 7,170,053, which patents are incorporated in their entirety herein, are within the scope of this invention.

While these theoretical considerations advocate use of H₂ and its mixtures in FAIMS, their benefits for resolution and speed are most clearly seen in the following demonstrations for representative analytes.

### Evaluation of FAIMS Using Hydrogen

Experiments described herein employed a planar FAIMS analyzer known in the art with a gap of 1.88 mm width, ˜50 mm length, and ˜30 mm span. The unit comprised two polished steel plates spaced by four ceramic washers and held within a PEEK enclosure by teflon screws installed inside said washers. Ions entered the unit through a curtain plate (cp) and orifice having the circular apertures of 2.5 mm and 1.5 mm in diameter, respectively, with cp biased at ˜0.7-1 kV. Buffer gas flowed into the unit at the gap edge, with some exiting through the cp/orifice interface and desolvating entering ions and the rest carrying ions through the gap. The device was secured in a metal frame ˜2 mm in front of the inlet capillary of an ion trap mass spectrometer (Thermo Scientific LTQ), with the following skimmer/orifice interface replaced for higher sensitivity by a custom electrodynamic ion funnel known in the art. The asymmetric waveform, delivered by a custom generator,had the bisinusoidal profile with optimum 2:1 harmonics ratio, 750 kHz frequency, and peak voltage (DV) up to 5.4 kV. The programmable compensation voltage (CV) creating the E_{c} field was output by a National Instrument card with the range of ±200 V and superposed on the waveform inside the generator. The card was controlled from a PC using custom software that allowed scanning the CV with a desired range and speed. An adjustable voltage of ˜100-200 V was added to the whole FAIMS unit to maximize the on transmission to the MS inlet held at a similar bias. The buffer gas flowing to the device was formulated by mixing H₂ and N₂, measured by flow controllers (MKS Instruments, Andover, Mass.) and passed through a filter for cleaning. Positive ions were generated by a single ESI emitter held at ˜1.6-2.3 kV above the cp voltage. The samples, dissolved in a common infusion solvent of 50/49/1 water/methanol/acetic acid, were delivered by a syringe pump at the flow rate of ˜0.3-0.6 μL/min.

Flammability of H₂ requires safety precautions, and the major concern is H₂ expelled into the lab environment. While some carrier gas enters the MS system and is evacuated with the exhaust, most comes into the lab from the FAIMS inlet and the unsealed FAIMS/MS interface, especially at elevated Q values. In a small and/or poorly ventilated space, this H₂ inflow can accumulate and cause fire or explosion, conceivably triggered by a spark discharge in the FAIMS unit or at the ESI/FAIMS or FAIMS/MS interfaces. Hence, experiments were conducted in a large, well-ventilated laboratory where even a continuous operation at maximum H₂ flow could not build up a dangerous H₂ concentration. Local H₂ concentrations near the FAIMS unit inlet and FAIMS/MS junction can still be high, and a discharge between the ESI emitter and cp can ignite the gas coming out of the FAIMS unit. Thus, at the higher H₂ fractions, we reduced the cp and ESI emitter offset voltages to the minima of above-stated ranges and increased the distance from the cp to the emitter. Risk of accidental leaks from the line taking H₂ from its source to the unit was mitigated: per applicable regulations, the H₂ cylinder was placed in a ventilated cabinet and connected to the unit using steel (rather than the common plastic) tubing with Swagelok fittings.

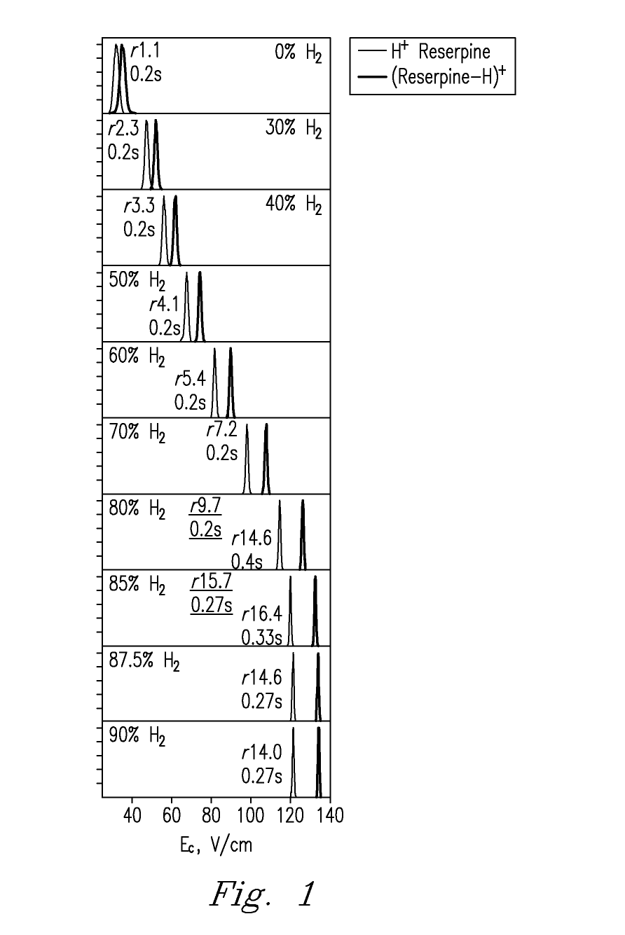

An accepted standard for MS, IMS, or FAIMS analyses is reserpine, which commonly contains 3,4-dehydroreserpine due to oxidative dehydrogenation. In positive-ESI mode, these produce 1+ protonated ions with m/z of 609 and 607, respectively. FIG. 1 shows the separation of 1+ reserpine and 3,4-dehydroreserpine ions in H₂/N₂ mixtures with 0-90% H₂ and filtering times as labeled (in the panels featuring two t values, the spectrum plotted is for the underlined t). Peak resolution of these species by FAIMS is shown. With the H₂ fraction growing from 0 to 80% (v/v), the r value at t=0.2 s increases 9-fold (from 1.1 to 9.7), as the peaks narrow while the distance between them expands. Even higher r˜15-16 were achieved at 80-88% H₂ using t=0.27-0.4 s, which is still shorter than 0.6 s needed for the maximum resolving power in He/N₂ mixtures.

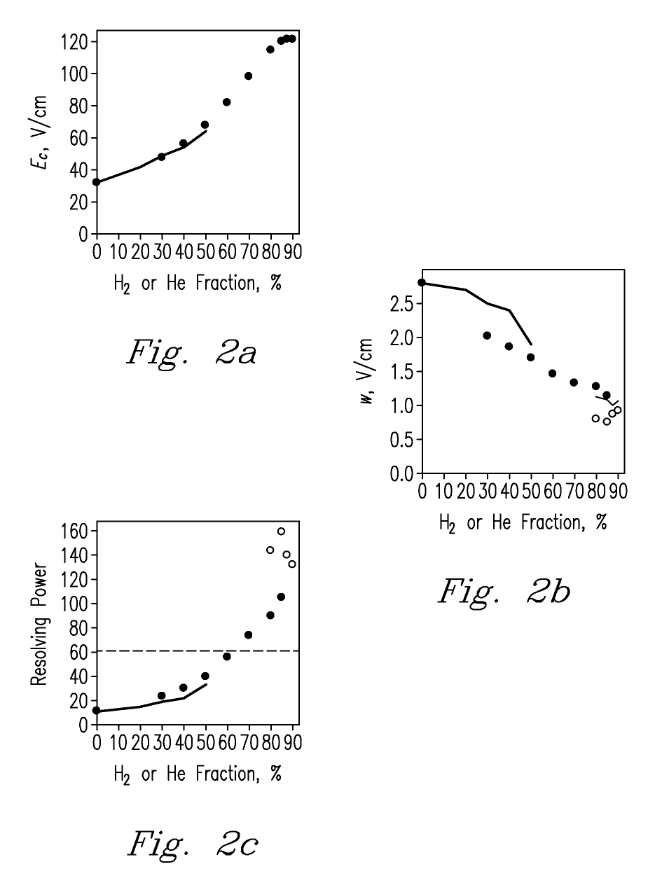

FIGS. 2a-2c compare separation properties for reserpine from FIG. 1 to those measured in He/N₂ mixtures using the same DV. FIG. 2a shows the compensation field (circles for H₂/N₂ and line for He/N₂ compositions). The values in H₂/N₂ mixtures are close to those in He/N₂ up to 50% H₂ or He, but at the near-maximum 90% H₂ exceed the highest in He/N₂ (at 50% He) by 1.9 times. The flattening of curve at ˜90% H₂ portends the E_{c} decrease at higher H₂ fractions, suggesting that those would not improve separation even if the electrical breakdown could be averted.

FIG. 2b shows the peak widths, with the measured values marked by circles for H₂/N₂ (filled for t=0.2 s and blank for t=0.27-0.4 s) and thick line for He/N₂ compositions. As expected from above calculations, the peaks measured using H₂/N₂ in t=0.2 s are somewhat narrower than those using He/N₂ mixtures for equal t and N₂ content (in the region of overlap up to 50% H₂), and the widths for >50% H₂ lie on the extrapolation of the trend up to 50% H₂. The values for t>0.2 s adjusted to t=0.2 s via multiplication by (t/0.2 s)^{1/2} (the thin line) track the same trend, also in agreement with theory.

FIG. 2c shows the resolving power, marked by the circles for H₂/N₂ (filled for t=0.2 s and blank for t=0.27-0.4 s) and solid line for He/N₂ compositions. The dashed line indicates the maximum R achieved with He/N₂ mixtures using extended t=0.6 s. With t=0.2 s, the resolving power exceeds that using He/N₂ already at 50% H₂ (because of narrower peaks) and rapidly increases at higher H₂ fractions as E_{c} values escalate—to 105 (or >3 times that in 1:1 He/N₂) at 85% H₂, The maximum R is ˜160 (also at 85% H₂) at t=0.4 s, which is 2.6 times that achieved using 1:1 He/N₂ despite a longer t=0.6 s. The resolution of different species improves in proportion (FIG. 1). Such resolution gains despite faster separation demonstrate the potential for FAIMS in hydrogen-rich mixtures.

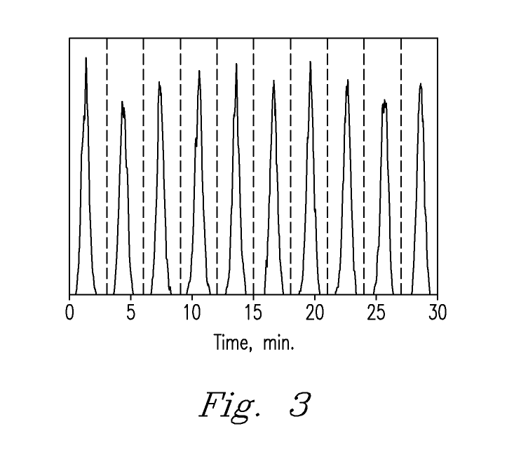

Data for peak widths and thus resolving power or resolution are verified by sufficient statistics. FIG. 3 shows 10 replicate peaks out of 20 consecutively acquired for reserpine at 85% H₂ and t=0.4 s. These data yield the mean w=0.755±0.031 V/cm at 95% confidence, leading to R=159±7.

More topical are separations of peptides, especially isomers such as derived from proteolytic digestion of isomeric proteins ubiquitous in biology. Major categories are sequence inversions where at least two residues are transposed and localization variants, where PTM(s) are moved along the backbone. These isomers normally have different biological activity, but are often challenging to characterize by tandem MS using ergodic methods such as collision-induced dissociation (CID). This is the case for sequence inversions with basic residues and/or permuted N-terminal and next residues. Particularly difficult are inversions of modified peptides with “electron predator” PTMs such as nitrate, which are preferentially abstracted during CID and produce uninformative fragments upon the electron capture or transfer dissociation (EC/TD). The problem is generally harder for localization variants because CID, again, causes PTM abstraction with uninformative fragments and PTM migration that yields misleading fragments, while EC/TD is inefficient and non-specific, leading to low sensitivity. Mixtures of three or more localization variants cannot be characterized by MS/MS (either CID or EC/TD) in principle because of the absence of unique fragments for at least one isomer. This situation calls for separation of peptide isomers prior to the MS step. Yet, known chromatographic and electrophoretic approaches to such separations are slow, require extensive method development, and deliver satisfactory resolution in only some cases. Such species were recently separated using FAIMS with He/N₂ mixtures, and below, the utility of H₂/N₂ in these applications is evaluated.

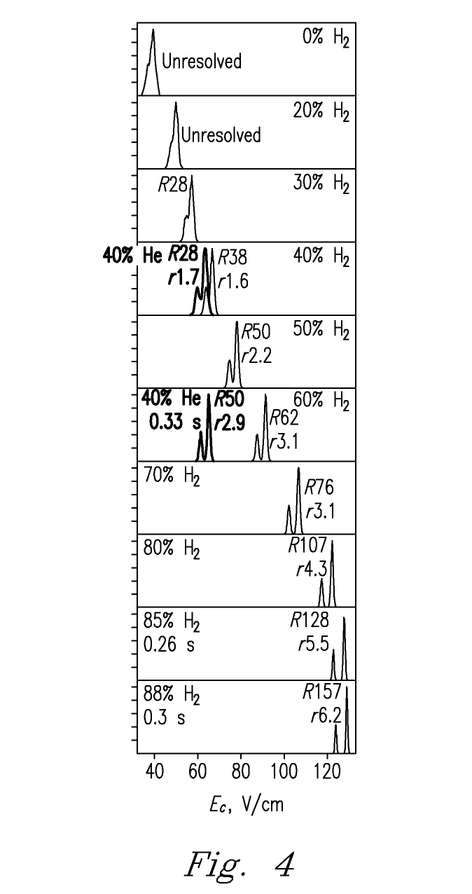

A model tryptic nitropeptide nYAAAAAAK (782 Da), where nY is nitrotyrosine, has 7 tryptic sequence isomers that were distinguished by FAIMS using He/N₂ mixtures (albeit not easily). For example, AnYAAAAK (3) and AAAnYAAAK (4) with nY shifted by a single residue were baseline-resolved as 1+ ions only at extended filtering times (at least 0.33 s). FIG. 4 shows the separation of nitropeptide isomers 3 and 4 in H₂/N₂ mixtures with 0-88% H₂ and filtering times of 0.2 s (except at >80% H₂). For comparison, the spectra in 40:60 He/N₂ obtained using t=0.2 s and 0.33 s are added to the panels with similar peak resolution in H₂/N₂. Isomer 3 always has a lower absolute E_{c}. The R and r values are marked. As seen here, the resolutions of isomers 3 and 4 obtained in He/N₂ with 40% He in t=0.2 and 0.33 s are matched using H₂/N₂ with 40% and 60% H₂, respectively, in t=0.2 s. In line with the results for reserpine, adding H₂ up to 88% about doubles the R and r values at a similar filtering time.

Modern proteomic analyses mainly involve ESI and related ion sources that tend to generate multiply protonated peptides, commonly with the charge state (z) of 2. Conformational, sequence, and localization isomers of peptides with z=2-4 were separated by FAIMS in He/N.) mixtures with the resolving power and resolution generally superior to those for 1+ ions. Whether H₂ mixtures may perform even better is thus of interest.

The overall resolving power for multiply-charged peptides may be addressed using Syntide 2 (PLARTLSVAGLPGKK, 1508 Da) that produces abundant 2+, 3+, and 4+ ions in ESI and was chosen as a benchmark in several FAIMS studies using He/N₂. Higher mobilities of 2+ and particularly 3+ and 4+ peptides bring about their faster elimination from the gap compared to 1+ peptides, effectively limiting the H₂ content for z=3 and 4 to less than 90%, namely ˜60% for z=4 and ˜70% for z=3. For the same reason, we could not employ an extended t to maximize the resolving power for these peptides at higher H₂ fractions, and had to measure the data for z=3 and 4 at ˜60-70% H₂ using t<0.2 s.

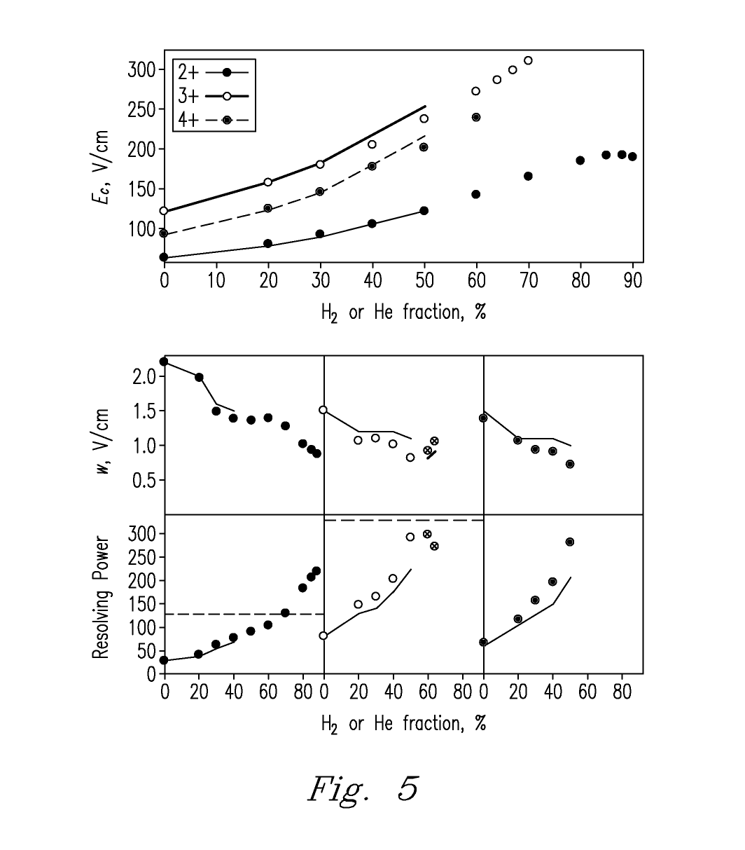

FIG. 5 compares the separation properties for major peaks of protonated Syntide 2 with z=2-4 in H₂/N₂ and He/N₂ mixtures: compensation field (top panel), peak width (middle row), and resolving power (bottom row). Sloping lines (except the thick line in middle row, center column) are for data in He/N₂ and circles are for H₂/N₂ (at t=0.2 s except the crosshair circles for z=3 at t=0.15-0.16 s). The thick line (middle row, center column) shows peak widths for z=3 upon adjustment to t=0.2 s as explained above. The dashed lines (bottom row) indicate the maximum R achieved for z=2 and 3 with He/N₂ mixtures (using t=0.5 s). At t=0.2 s, the maximum E_{c} values (obtained at or near the highest possible H₂ fractions) exceed those in 1:1 He/N₂ for all z: by ˜60% for z=2 and ˜10-20% for z=3 and 4. The smaller increases for 3+ and particularly 4+ ions are consequent upon a lower maximum H₂ content, as the absolute E_{c} would be higher at ˜85-90% H₂ In other aspects, the findings follow the trends for 1+ ions noted above: the peak widths in H₂/N₂ mixtures are slightly below those in He/N₂ with equal N₂ fractions up to the maximum He content (50%), then decrease along the same linear trends until t has to be reduced, and then stay roughly level. As the result, at t=0.2 s, the maximum resolving powers exceed those obtained using He/N₂ mixtures by ˜3 times (R˜200 vs. ˜70) for z=2 and ˜30-40% (R˜280-300 vs. ˜200-220) for z=3 and 4. For z=2, the R˜200 achieved here is greater than ˜130 reached in He/N₂ using the longest feasible t=0.5 s. The diminishing benefit of H₂ substitution for higher peptide charge states at least partly results from increasing K values that preclude the highest H₂ fractions with the current restricted gaps. This is a limitation of the present embodiment rather than the invention as such, and can be remedied employing more powerful waveform generators as specified above.

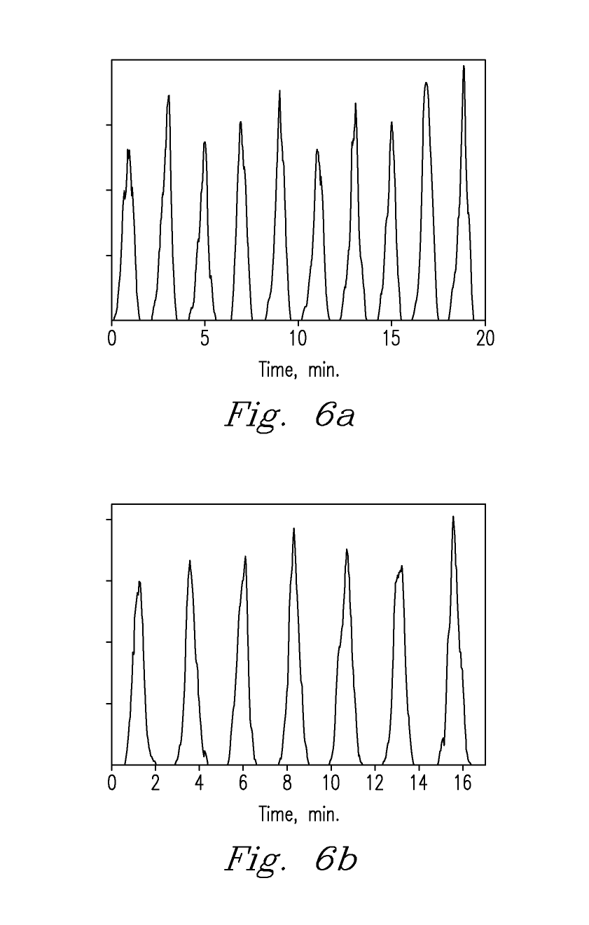

Results for Syntide 2 ions were also validated by statistics. FIG. 6a shows 10 replicate peaks out of 18 consecutively acquired for 2+ ions at 84% H₂ using t=0.2 s. The mean w in these spectra is 1.03±0.064 V/cm at 95% confidence, leading to R=185±12. FIG. 6b shows 7 replicates for 3+ ions at 50% H₂ and t=0.2 s, with the mean w of 0.818±0.060 V/cm and R of 291±21.

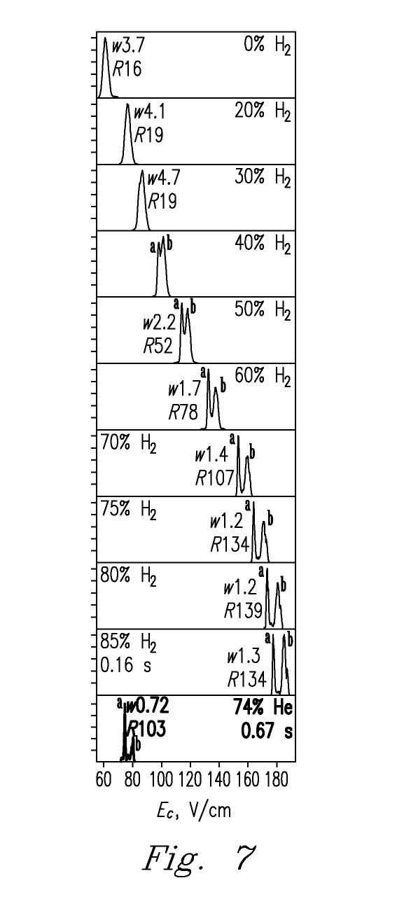

Gas-phase proteins and peptides commonly exhibit multiple conformers, some mirroring those in solution. Their separation and characterization is of interest for fundamental structural biology and clinically relevant investigations into protein misfolding disorders. The utility of hydrogen-containing media for separation of peptide conformers (in particular, multiply-charged ones) was gauged using 2+ ions of bisphosphorylated APLpSFRGSLPKpSYVK (1809 Da). FIG. 7 shows the spectra for these ions in H₂/N₂ mixtures with 0-85% H₂ as labeled and t=0.2 s (except at 85% H₂), and (bottom panel) He/N₂ using DV=4 kV and 74% He—the maximum avoiding the electrical breakdown. The widths (V/cm) and resolving power values are given for the major well-defined peak. As with Syntide 2, the absolute E_{c} values increase upon H₂ addition, while peak widths decrease with fixed t and remain constant with reduced t at >80% H₂. These gains translate into improving resolution, with the conformers (a) and (b) separated increasingly well. The spectrum at 70% H₂ resembles that in He/N₂ with the maximum He content, while those at 75-85% H₂ exhibit slightly better resolution. Summarizing, FAIMS in hydrogen-rich mixtures allows faster filtering singly or multiply-charged peptides with specificity close to or exceeding that in He/N₂ media. The relative separation parameters for both primary and secondary structure isomers track those in He/N₂.

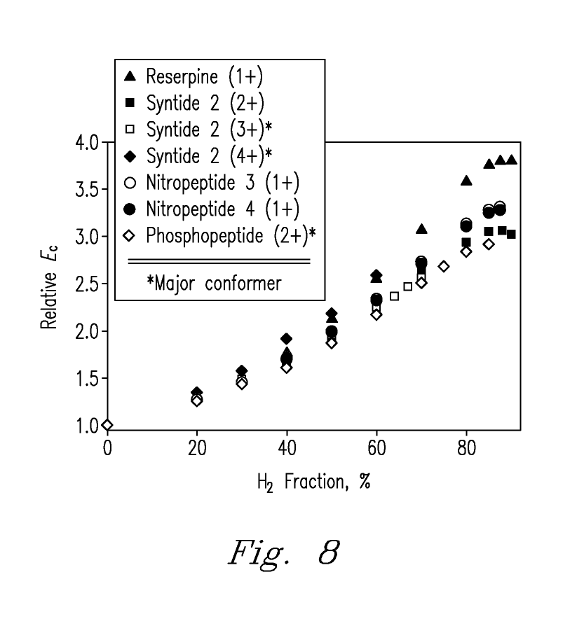

The invention can benefit from a capability to predict the separation properties for various ions in H₂/N₂ mixtures of arbitrary composition. FIG. 8 shows the E_{c} values in H₂/N₂ for all sp above relative to those for the sane ions in N₂. The resulting curves allow roughly projecting E_{c} for other species based on the data in N₂ (for example, to select the E_{c} scan range). All ions in FIG. 8 are fairly large and have negative K(E) dependences (i.e., are “type C” species) in N₂. Then addition of less polarizable H₂ molecules turns the K(E) dependences even more negative and E_{c} values increase. Smaller ions with positive K(E) dependences in N₂ (“type A”) may behave differently, and some must switch to type C with increasing H₂ fraction (as they do above some He fraction in He/N₂). However, most biomolecular ions of interest are type C in N₂ and are expected to track the curve in FIG. 8.

### Application Modalities

The invention finds application in both FAIMS alone and instrumentation integrating FAIMS with other stages such as MS; conventional IMS implemented in the drift-tube, traveling-wave, and other modalities; spectroscopy including, but not limited to, photoelectron and photodissociation spectroscopy; and combinations thereof. Stand-alone systems include those in public locations such as screening stations in airports, ports, border posts, high-value buildings, and public venues. The acceleration of FAIMS scanning should facilitate its incorporation into LC/MS protocols. Unlike helium, hydrogen is readily producible at essentially no cost beyond the one-time expense of commercial generating equipment. This reduces the operating cost of FAIMS systems, making them more broadly attractive, especially in many countries where He is more expensive and/or less available than in the US. Use of H₂ that can be produced on demand from compactly stored inert materials or via electrolysis of ambient water should make high-resolution FAIMS devices more portable and autonomous. Finally, shorter filtering times allow decreasing the gap length and capacitance of FAIMS analyzers, which reduces the power requirements and thus weight and cost of waveform generators. In one embodiment, the invention may be configured for in-situ analyses of hydrogen-rich atmospheres of exoplanets, e.g., Jupiter and Saturn with 87-96% H₂.

While a number of embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A buffer medium for differential ion mobility spectrometry comprising hydrogen gas.

2. The medium of claim 1, wherein hydrogen has a volume fraction exceeding 70%.

3. The medium of claim 1, wherein the medium is a binary gas mixture.

4. The medium of claim 3, wherein the medium includes a mixture of hydrogen (H₂) and nitrogen (N₂).

5. The medium of claim 3, wherein the medium includes a mixture of H₂ and carbon dioxide (CO₂).

6. The medium of claim 3, wherein the medium includes a mixture of H₂ and argon (Ar).

7. The medium of claim 3, wherein the medium includes a mixture of H₂ and helium (He).

8. The medium of claim 1, wherein the medium comprises at least two gases besides H₂.

9. The medium of claim 8, wherein the medium is a ternary mixture of H₂, N₂, and CO₂.

10. The r Medium of claim 8, wherein the medium is a ternary mixture of H₂, He, and one other gas.

11. The medium of claim 8, wherein said at least two gases are selected from the group consisting of: N₂, CO₂, Ar, He, sulfur hexafluoride (SF₆), and combinations thereof.

12. The medium of claim 1, wherein the medium further comprises a vapor of at least one substance.

13. The medium of claim 12, wherein the at least one substance includes a volatile organic.

14. The medium of claim 12, wherein the medium further comprises at least one gas besides H₂.

15. A method for performing differential ion mobility separations, including the step of:
introducing a buffer gas comprising H₂ into the analytical gap of a separation device where ions are filtered by an asymmetric electric field.

16. The method of claim 15, wherein the volume fraction of H₂ in said buffer gas is at least about 70%.

17. The method of claim 15, wherein the pressure of said gas is the ambient atmospheric pressure, or wherein said pressure ranges from about 50 Torr to about 1 atm; or wherein said pressure ranges from about 1 atm to about 5 atm.

18. The method of claim 15, wherein ions are propelled along said gap by a gas flow.

19. The method of claim 18, wherein said gas flow is driven by the vacuum suction into a following instrument stage maintained at a lower gas pressure selected from the group consisting of: a mass spectrometer, ion mobility spectrometer, differential ion mobility spectrometer, photoelectron spectrometer, photodissociation spectrometer, and combinations thereof.

20. The method of claim 15, wherein ions are propelled along said gap by a longitudinal electric field derived from a ladder of voltages along the gap superposed on the alternating voltage that establishes said asymmetric field.

21. The method of claim 15, wherein said separations involve higher-order differential ion mobility spectrometry (HODIMS) wherein ions are sorted by the 2^{nd} or higher derivative of mobility as a function of the electric field intensity, or IMS with alignment of dipole direction (IMS-ADD) wherein said electric field aligns the ion dipoles.

22. The method of claim 15, wherein said separations are preceded or followed by other analytical methods, selected from the group consisting of: mass spectrometry, ion mobility spectrometry, differential ion mobility spectrometry, photoelectron spectrometry, photodissociation spectrometry, and combinations thereof.
